(19) United States
(12) Patent Application Publication
(10) Pub. No.: US 2026/0138007 A1
(43) Pub. Date: May 21, 2026

(54) SYSTEM, METHOD, AND NON-TRANSITORY COMPUTER-READABLE STORAGE MEDIUM

(71) Applicant: NINTENDO CO., LTD., Kyoto (JP)

(72) Inventors: Taiyo WATANABE, Kyoto (JP); Masayuki SHAMOTO, Kyoto (JP); Masahiro YOSHINO, Kyoto (JP); Hiroki TAKEI, Kyoto (JP); Takahiro KAWAHARA, Kyoto (JP)

(21) Appl. No.: 19/370,087

(22) Filed: Oct. 27, 2025

(30) Foreign Application Priority Data
Nov. 18, 2024 (JP) 2024-200730

(51) Int. Cl. A63F 13/25; A63F 13/98

(52) U.S. Cl. CPC A63F 13/25; A63F 13/98

(57) ABSTRACT

A system includes a plurality of main body apparatuses and a plurality of controllers removably attachable to the main body apparatuses. The system includes a receiver that receives from a first main body apparatus, first data corresponding to an appearance of a first controller attached to the first main body apparatus, a generator that generates a third image including a first image that depicts an appearance of the main body apparatus and a second image that depicts the appearance of the first controller based on the first data, and a representation control unit that causes second main body apparatus different from the first main body apparatus to show the third image.

This non-provisional application is based on Japanese Patent Application No. 2024-200730 filed with the Japan Patent Office on Nov. 18, 2024, the entire contents of which are hereby incorporated by reference.

### FIELD

The present disclosure relates to a system, a method, and a non-transitory computer-readable storage medium.

### BACKGROUND AND SUMMARY

A game terminal to which a controller is removably attachable, the game terminal being capable of performing game processing, has been known.

As a large number of game terminals are distributed on markets, one household may own a plurality of game terminals or a single user may own a plurality of game terminals. In such a case, for example, when other game terminals are shown in a display screen of a certain game terminal, simply showing names for identification of individual other terminals may not be sufficient for distinction as to which game terminal is intended.

(Configuration 1) An exemplary embodiment provides a system that includes a plurality of main body apparatuses and a plurality of controllers removably attachable to the main body apparatuses. The system includes a receiver that receives from a first main body apparatus, first data corresponding to an appearance of a first controller attached to the first main body apparatus, a generator that generates a third image including a first image that depicts an appearance of the main body apparatus and a second image that depicts the appearance of the first controller based on the first data, and a representation control unit that causes second main body apparatus different from the first main body apparatus to show the third image.

(Configuration 2) In Configuration 1, when no controller is attached to the first main body apparatus, the receiver receives from the first main body apparatus, the first data corresponding to an appearance of a controller last attached to the first main body apparatus.

(Configuration 3) In Configuration 1 or 2, the operations comprising generating a sixth image comprising a fourth image that depicts an appearance of the main body apparatus and a fifth image that depicts an appearance of a second controller attached to the second main body apparatus and causing the second main body apparatus to show the sixth image with the third image.

(Configuration 4) In any of Configurations 1 to 3, the first data includes information indicating a color of the first controller.

(Configuration 5) In any of Configurations 1 to 4, the system further includes a first server configured to persistently be connected to at least the first main body apparatus, and the first server includes the receiver.

(Configuration 6) In any of Configurations 1 to 5, the operations comprising receiving second data corresponding to the appearance of the first main body apparatus from the first main body apparatus, wherein the first image depicts the appearance of the first main body apparatus based on the second data.

(Configuration 7) In Configuration 3, the first image and the fourth image are a common image that depicts the main body apparatus.

(Configuration 8) Another exemplary embodiment provides a method to be used in a system including a plurality of main body apparatuses and a plurality of controllers removably attachable to the main body apparatuses. The method includes receiving from a first main body apparatus, first data corresponding to an appearance of a first controller attached to the first main body apparatus, generating a third image including a first image that depicts an appearance of the main body apparatus and a second image that depicts the appearance of the first controller based on the first data, and causing second main body apparatus different from the first main body apparatus to show the third image.

(Configuration 9) In Configuration 8, when no controller is attached to the first main body apparatus, the first data received from the first main body apparatus corresponds to an appearance of a controller last attached to the first main body apparatus.

(Configuration 10) In Configuration 8 or 9, the method comprising generating a sixth image comprising a fourth image that depicts an appearance of the main body apparatus and a fifth image that depicts an appearance of a second controller attached to the second main body apparatus and causing the second main body apparatus to show the sixth image with the third image.

(Configuration 11) In any of Configurations 8 to 10, the first data includes information indicating a color of the first controller.

(Configuration 12) In any of Configurations 8 to 11, the system further includes a first server configured to persistently be connected to at least the first main body apparatus, and the receiving first data is performed by the first server.

(Configuration 13) In any of Configurations 8 to 12, the method comprising receiving second data corresponding to the appearance of the first main body apparatus from the first main body apparatus, wherein the first image depicts the appearance of the first main body apparatus based on the second data.

(Configuration 14) In Configuration 10, the first image and the fourth image are a common image that depicts the main body apparatus.

(Configuration 15) Another exemplary embodiment provides a program to be used in a server that communicates with a first main body apparatus configured such that a controller is removably attachable thereto and another main body apparatus different from the first main body apparatus and includes one or more processors. The program causes the one or more processors to perform receiving from the first main body apparatus, first data corresponding to an appearance of a first controller attached to the first main body apparatus and generating a third image including a first image that depicts an appearance of a main body apparatus and a second image that depicts the appearance of the first controller based on the first data, and causing second main body apparatus different from the first main body apparatus to show the third image.

(Configuration 16) In Configuration 15, when no controller is attached to the first main body apparatus, the first data, the first data received from the first main body apparatus corresponds to an appearance of a controller last attached to the first main body apparatus.

(Configuration 17) In Configuration 15 or 16, the operations comprising generating a sixth image comprising a fourth image that depicts the appearance of the main body apparatus and a fifth image that depicts an appearance of a second controller attached to the second main body apparatus and causing the second main body apparatus to show the sixth image with the third image.

(Configuration 18) In any of Configurations 15 to 17, the first data includes information indicating a color of the first controller.

(Configuration 19) In any of Configurations 15 to 18, the server is persistently connected to at least the first main body apparatus.

(Configuration 20) In any of Configurations 15 to 19, the operations comprising receiving second data corresponding to an appearance of the first main body apparatus from the first main body apparatus, wherein the first image depicts the appearance of the first main body apparatus based on the second data.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary system according to the present embodiment.

FIG. 2 shows an exemplary illustrative non-limiting drawing illustrating an exemplary hardware configuration of a persistent connection server included in the system according to the present embodiment.

FIG. 3 shows an exemplary illustrative non-limiting drawing illustrating an exemplary hardware configuration of a main body apparatus included in the system according to the present embodiment.

FIG. 4 shows an exemplary illustrative non-limiting drawing illustrating an exemplary hardware configuration of a controller included in the system according to the present embodiment.

FIG. 5 shows an exemplary illustrative non-limiting drawing illustrating an exemplary hardware configuration of a terminal included in the system according to the present embodiment.

FIG. 6 shows an exemplary illustrative non-limiting drawing illustrating a flowchart for illustrating processing for transmitting a data package to the persistent connection server.

FIG. 7 shows an exemplary illustrative non-limiting drawing illustrating an exemplary sequence showing exemplary use of controller appearance information.

FIG. 8 shows an exemplary illustrative non-limiting drawing illustrating an exemplary image shown on a display of the main body apparatus.

FIG. 9 shows an exemplary illustrative non-limiting drawing illustrating an exemplary image shown at the terminal.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### Embodiment

### a. Overview

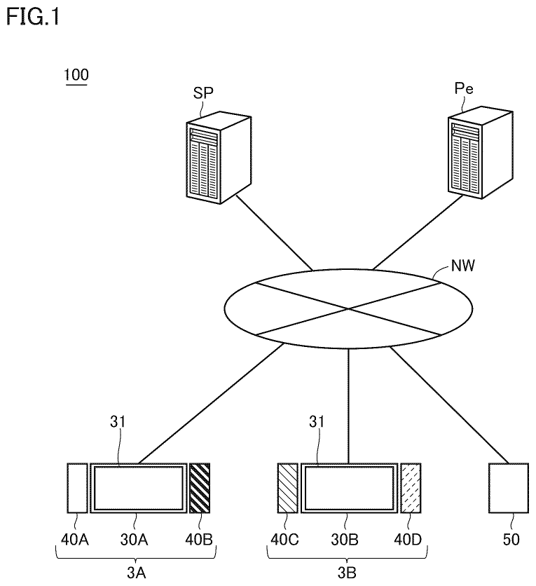

An exemplary configuration of a system 100 according to the present embodiment will be described. Exemplary system 100 according to the present embodiment will be described with reference to FIG. 1. System 100 is a system that provides a service to game terminals 3A and 3B, a terminal 50, and the like, for example, with a persistent connection server Pe.

System 100 includes game terminals 3A and 3B, a service providing server SP, a persistent connection server Pe, and terminal 50 by way of example. Elements included in system 100 are connectable to one another over a network NW. Network NW is, for example, the Internet.

Game terminal 3A includes a main body apparatus 30A and controllers 40A and 40B, and game terminal 3B includes a main body apparatus 30B and controllers 40C and 40D. Hereinafter, game terminals 3A and 3B will collectively be referred to as a “game terminal 3” without being distinguished from each other, main body apparatuses 30A and 30B will collectively be referred to as a “main body apparatus 30” without being distinguished from each other, and controllers 40A to 40D will collectively be referred to as a “controller 40” without being distinguished from one another. Game terminal 3 may be, for example, an information processing apparatus exclusive for gaming. Game terminal 3 may be any of portable, stationary, and hybrid game terminals. Game terminal 3 may be a general-purpose PC, a smartphone, or the like that can execute a game application program. Terminal 50 may be, for example, an information processing terminal such as a smartphone, a tablet, or a general-purpose PC.

Main body apparatus 30 is configured such that controller 40 is removably attachable thereto. Main body apparatus 30 may include a display 31 that covers a front surface of main body apparatus 30 as a whole; the display covers, for example, 80% or more of an area of the front surface of main body apparatus 30. Display 31 does not have to cover the entire front surface of main body apparatus 30, and for example, it may cover half or more of the area of the front surface of main body apparatus 30. Controllers 40 may be different from each other in appearance such as a shape or a color. In an example in FIG. 1, controllers 40A to 40D are each colored differently. Controller 40A and controller 40B may be different from each other in arrangement or shape of a user-operable portion such as a button at their surfaces. This is also applicable to controller 40C and controller 40D. Controller 40A and controller 40C may be identical in arrangement or shape of the user-operable portion. This is also applicable to controller 40B and controller 40D.

In the present embodiment, persistent connection server Pe provides a persistent connection service. The persistent connection service may include a service to collect information on game terminal 3 from main body apparatus 30 at any timing, by maintaining connection between persistent connection server Pe and main body apparatus 30. The persistent connection service provides such a connection scheme that main body apparatus 30 persistently keeps maintaining connection to persistent connection server Pe while main body apparatus 30 is connectable to network NW. Examples in which connection between main body apparatus 30 and persistent connection server Pe is no longer maintained include disconnection from network NW due to occurrence of a malfunction or a fault of network NW, transition of main body apparatus 30 to an in-flight mode or the like, power-off of main body apparatus 30, and the like.

Information on game terminal 3 may include controller appearance information that allows specifying an appearance of controller 40 attached to main body apparatus 30 or specifying an appearance of controller 40 that was attached to main body apparatus 30 in the past. Controller appearance information 461 which will be described later may be, for example, information that allows specifying a color of controller 40, controller model information indicating a shape of controller 40, or information including both of them. For example, controller appearance information 461 may be RGB information indicating the color of controller 40.

Furthermore, the information on game terminal 3 may include, for example, at least one of main body appearance information 363 for specifying an appearance of main body apparatus 30 which will be described later, firmware version information of main body apparatus 30, nickname information registered in main body apparatus 30, and storage capacity information of main body apparatus 30. Main body appearance information 363 may be information for specifying the color of main body apparatus 30, main body model information indicating a shape of main body apparatus 30, or information including both of them. A bunch of data that includes this information on game terminal 3 and is transmitted at any timing from main body apparatus 30 to persistent connection server Pe is referred to as a “data package.” Persistent connection server Pe may manage a plurality of game terminals 3 by holding the data package obtained from each of the plurality of game terminals 3. All of various types of information included in the data package do not have to collectively be transmitted at once but may be transmitted separately for each content of the various types of information.

Persistent connection server Pe may update the entire information on game terminal 3 managed at a side thereof or update only information different from the information on game terminal 3 held thereby, for example, based on the information on game terminal 3 included in the data package transmitted from main body apparatus 30. The information on game terminal 3 is thus synchronized between persistent connection server Pe and game terminal 3. A type of information included in the data package may be predetermined.

Service providing server SP may be a server that performs, for example, processing specialized in a specific service. Exemplary services provided by service providing server SP include a service to have a plurality of game terminals 3 exchange information and a service to have a communication terminal such as terminal 50 supervise a state of game terminal 3. Service providing server SP may request persistent connection server Pe to provide information on game terminal 3 connected to persistent connection server Pe in order to provide the service to certain game terminal 3 or terminal 50.

Though FIG. 1 shows only two game terminals 3A and 3B as game terminal 3 by way of example, actually, not-shown several ten, several hundred, or more game terminals 3 may be connected to persistent connection server Pe. The number of terminals 50 is not limited to one either, and there may be a plurality of terminals. Furthermore, service providing server SP and persistent connection server Pe may each include a plurality of physical servers. System 100 may include other servers, terminals, and the like that provide a service other than the services described above.

### B. Exemplary Hardware Configuration

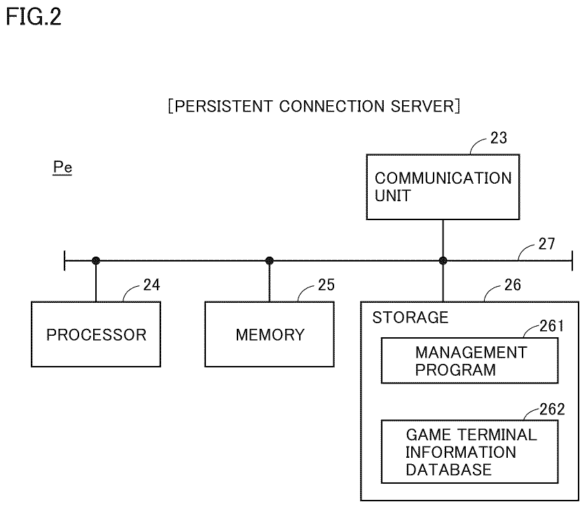

An exemplary hardware configuration of persistent connection server Pe, main body apparatus 30, controller 40, and terminal 50 included in system 100 according to the present embodiment will be described below with reference to FIGS. 2 to 5.

An exemplary hardware configuration of persistent connection server Pe included in system 100 according to the present embodiment will be described with reference to FIG. 2. Referring to FIG. 2, persistent connection server Pe includes one or more processors 24, a memory 25, a storage 26, and a communication unit 23. These components are connected to communicate data with one another through a bus 27. Persistent connection server Pe may be an information processing apparatus exclusively for providing the persistent connection service, or may be implemented by a general-purpose server.

Communication unit 23 communicates with other information processing terminals included in system 100 over network NW. Communication unit 23 is provided with at least one of hardware necessary for wired communication and hardware necessary for wireless communication. The entirety or a part of processing by communication unit 23 may be performed by processor 24.

Processor 24 is a processing entity for performing processing provided by persistent connection server Pe. The term “processor” in the present disclosure means processing circuitry such as a central processing unit (CPU), a micro processing unit (MPU), or a graphics processing unit (GPU). The term “processor” encompasses processing circuitry that performs processing in accordance with instruction codes described in a program, processing circuitry in which a plurality of functions are integrated, such as a system on chip (SoC), hard-wired circuitry, and the like.

Memory 25 is a volatile storage device accessible by processor 24, and for example, a dynamic random access memory (DRAM), a static random access memory (SRAM), or the like may be employed as memory 25. Storage 26 is a non-volatile storage device accessible by processor 24, and for example, a hard disk, a flash memory, or the like may be employed as storage 26. Storage 26 may be, for example, a storage medium attachable to and removable from persistent connection server Pe, such as an optical disc and a cartridge.

At least a management program 261 and a game terminal information database 262 may be stored in storage 26. Processor 24 reads management program 261 and develops and executes the same on memory 25. The term “memory” herein encompasses at least both of a volatile memory and a non-volatile storage.

Management program 261 may be a program for collection and management of information on game terminal 3. Processing to be performed by management program 261 may include processing for obtaining the data package from game terminal 3 and processing for providing information on game terminal 3 in response to a request from service providing server SP. Game terminal information database 262 may be a database in which information on each game terminal generated based on the data package obtained from main body apparatus 30 is put together.

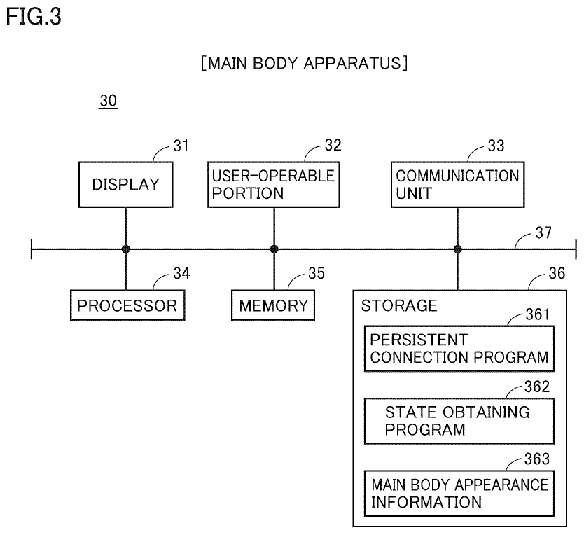

An exemplary hardware configuration of main body apparatus 30 included in system 100 according to the present embodiment will be described with reference to FIG. 3. Main body apparatus 30 includes a display 31, a user-operable portion 32, a communication unit 33, one or more processors 34, a memory 35, and a storage 36 that are connected to communicate data with one another through a bus 37.

Display 31 shows an image generated as a result of information processing performed by processor 34. User-operable portion 32 accepts an operation by a user. User-operable portion 32 may include, for example, at least one of a push button, an operation lever, and a touch panel. Such components as display 31 and user-operable portion 32 do not have to be included in main body apparatus 30. These components may be, for example, removable from main body apparatus 30, or may be external apparatuses that are different from main body apparatus 30 and connectable through a wire or wirelessly.

At least a persistent connection program 361, a state obtaining program 362, and main body appearance information 363 may be stored in storage 36. Persistent connection program 361 is a program for realizing the persistent connection service. Processing to be performed by persistent connection program 361 may include, for example, processing for transmitting the data package to persistent connection server Pe at any timing.

State obtaining program 362 is a program for obtaining information on game terminal 3. Processing to be performed by state obtaining program 362 includes, for example, processing for obtaining from newly attached controller 40, appearance information of that controller 40.

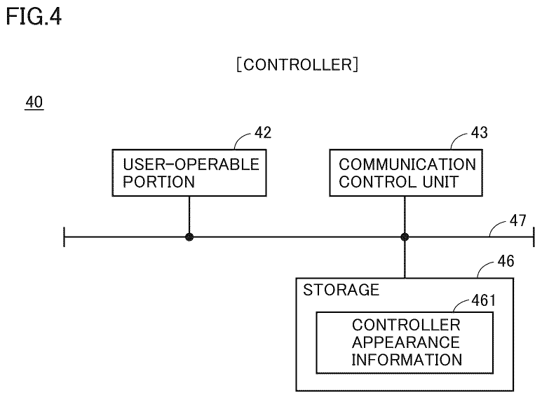

An exemplary hardware configuration of controller 40 included in system 100 according to the present embodiment will be described with reference to FIG. 4. Controller 40 includes a user-operable portion 42, a communication control unit 43, and a storage 46 that are connected to communicate data with one another through a bus 47. Communication control unit 43 may communicate with main body apparatus 30.

Communication control unit 43 controls communication with main body apparatus 30 to which controller 40 is attached. Communication control unit 43 may include, for example, a microprocessor, a terminal for connection to main body apparatus 30, or the like. Communication control unit 43 may perform various types of processing by executing firmware stored in storage 46. Communication control unit 43 may be able to communicate with main body apparatus 30 through wired communication via the terminal and wireless communication not via the terminal. Wireless communication between main body apparatus 30 and communication control unit 43 may be established, for example, in accordance with Bluetooth® standards.

User-operable portion 42 may include, for example, at least one of a push button, an operation lever, a touch panel, a mouse, a keyboard, and a 3D stick. User-operable portion 42 repeatedly outputs to communication control unit 43 at appropriate timing, information on a user operation performed thereon. Communication control unit 43 transmits to attached main body apparatus 30, operation data including obtained information. As the operation data is transmitted to main body apparatus 30, main body apparatus 30 can obtain input by a user provided to controller 40.

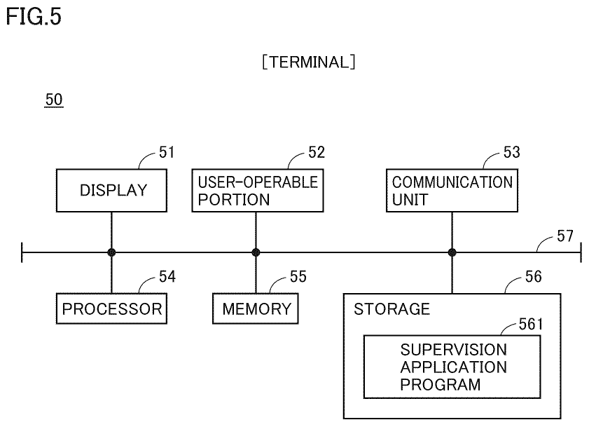

An exemplary hardware configuration of terminal 50 included in system 100 according to the present embodiment will be described with reference to FIG. 5. Terminal 50 includes a display 51, a user-operable portion 52, a communication unit 53, one or more processors 54, a memory 55, and a storage 56 that are connected to communicate data with one another through a bus 57. Storage 56 may include a supervision application program 561. Supervision application program 561 is a program for management of another game terminal 3 associated with an account of terminal 50.

### C. Processing for Transmitting Data Package to Persistent Connection Server

Persistent connection program 361 causes game terminal 3 to perform processing for transmitting the data package to persistent connection server Pe based on a prescribed transmission condition being satisfied, by way of example. The transmission condition may be change of contents of data included in the data package or another condition. Specifically, the transmission condition may be, for example, the fact that controller 40 has newly been attached to main body apparatus 30 to which controller 40 is yet to be attached, the fact that a storage capacity of main body apparatus 30 has been changed, or the fact that nickname information registered in main body apparatus 30 has been changed. In other words, the transmission condition may be change of at least a part of information included in the data package. In an example where the information included in the data package is predetermined, the entire predetermined information may be transmitted also when a part of the information is changed. Game terminal 3 may transmit the data package to persistent connection server Pe at prescribed communication intervals.

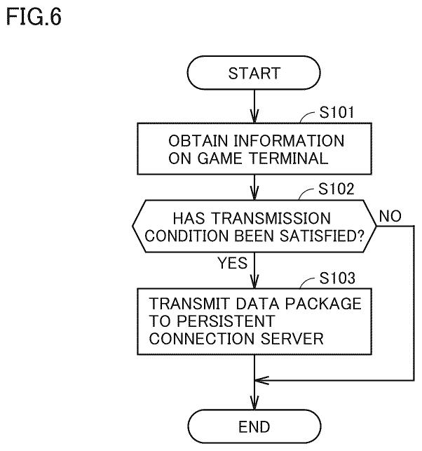

An exemplary flowchart for illustrating processing for transmitting the data package to persistent connection server Pe will be described with reference to FIG. 6. The flowchart shown in FIG. 6 may be started, for example, based on such a condition as lapse of a prescribed interval or another condition. In the present embodiment, main body apparatus 30 executes state obtaining program 362 and obtains information on game terminal 3 (step S101). Main body apparatus 30 determines whether or not the transmission condition has been satisfied (step S102). When the transmission condition has been satisfied (YES in step S102), main body apparatus 30 transmits the data package including the information on game terminal 3 obtained in step S101 to persistent connection server Pe (step S103) and the process ends. When the transmission condition has not been satisfied (NO in step S102), main body apparatus 30 does not perform step S103 and the process ends. Main body apparatus 30 may obtain only information indicating the changed contents included in the data package and transmits only the information indicating the changed contents (step S103).

In step S101, main body apparatus 30 has the obtained information on game terminal 3 temporarily held in memory 35. Main body apparatus 30 may erase the obtained information on game terminal 3 after it transmits the information to persistent connection server Pe. Main body apparatus 30 can thus transmit most recent information on game terminal 3 to persistent connection server Pe. The transmission condition may or may not include the fact that controller 40 has been removed. In the present embodiment, an example in which the fact of removal of controller 40 is not included in the transmission condition will be described. Main body apparatus 30 may perform step S102 before step S101. Specifically, main body apparatus 30 may obtain the information on game terminal 3 when the transmission condition is satisfied, and then transmit the obtained information on game terminal 3 as being incorporated in the data package.

In step S103, game terminal 3 may transmit the entire information included in the data package, or specify updated information in the information included in the data package and then transmit only the updated information. Persistent connection server Pe may update the entire information included in the data package in game terminal information database 262 at the time of reception of the data package, or when there is information identical in content to information already stored in game terminal information database 262 in the information included in the received data package, it does not have to update such information.

### D. Example in which Controller Appearance Information is Used in Service

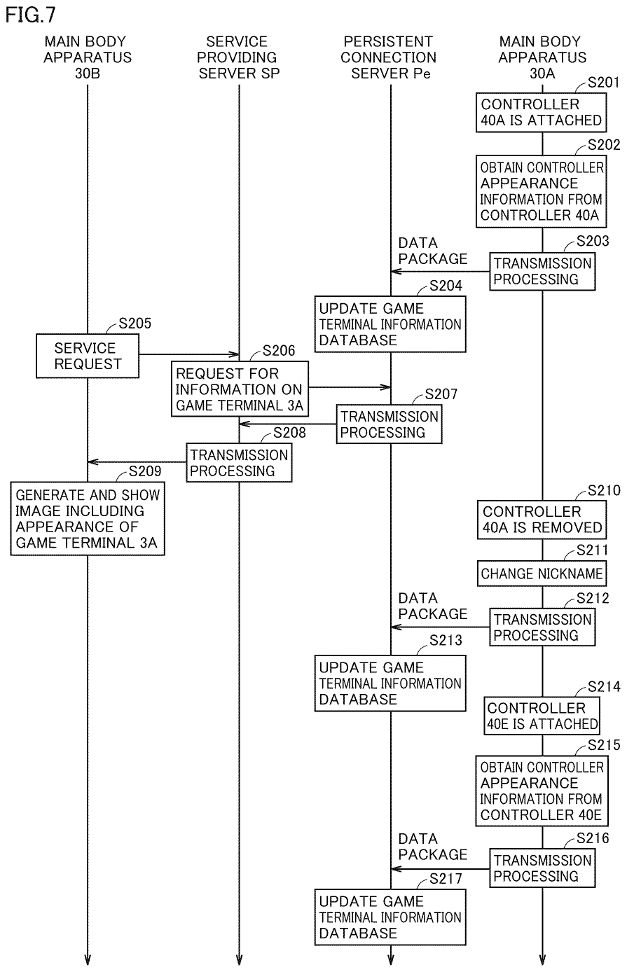

An exemplary sequence showing exemplary use of appearance information of controller 40 will be described with reference to FIG. 7. Initially, transmission of the data package from main body apparatus 30A to persistent connection server Pe and holding of the information on game terminal 3A in persistent connection server Pe in steps S201 to S204 will be described. From a state of main body apparatus 30A to which only controller 40B is attached, controller 40A is newly attached to main body apparatus 30A (step S201). Game terminal 3A obtains controller appearance information 461 from controller 40A based on the fact that controller 40A has newly been attached (step S202).

Since the transmission condition of new attachment of controller 40 has been satisfied, game terminal 3A performs transmission processing for transmitting the data package to persistent connection server Pe (step S203). The data package includes at least controller appearance information 461 obtained from controller 40A. Persistent connection server Pe updates game terminal information database 262 in connection with game terminal 3A based on the data package received from game terminal 3A (step S204). In other words, persistent connection server Pe updates the held information on game terminal 3A to a most recent state.

In succession, an example where game terminal 3B uses service providing server SP in steps S205 to S209 will be described. FIG. 7 illustrates an example where the service provided by service providing server SP is a service for having game terminal 3B and game terminal 3A exchange information. For example, a user of game terminal 3B operates game terminal 3B to perform processing for registering game terminal 3A as a game terminal where a virtual game card is interchangeably inserted.

Main body apparatus 30B requests service providing server SP to provide a service to communicate with game terminal 3A (step S205). Based on reception of a service request, service providing server SP requests persistent connection server Pe to provide the information on game terminal 3A in order to obtain the information on game terminal 3A (step S206).

Upon reception of the request from service providing server SP, persistent connection server Pe transmits the information on game terminal 3A to service providing server SP based on game terminal information database 262 (step S207). The information on game terminal 3A transmitted in step S207 includes appearance information of controllers 40A and 40B attached to main body apparatus 30A. The information may be only designated information such as the appearance information alone, or the entire data to be updated in step S204.

Service providing server SP transmits the appearance information of controllers 40A and 40B attached to main body apparatus 30A to main body apparatus 30B based on the information received in step S207 (step S208). Main body apparatus 30B generates an image P10 including images P40A and P40B which will be described later based on the appearance information of controllers 40A and 40B and shows the image on display 31 thereof (step S209). Image P10 may be generated by persistent connection server Pe or service providing server SP rather than main body apparatus 30B, and in this case, image P10 itself may be transmitted in steps S207 and S208.

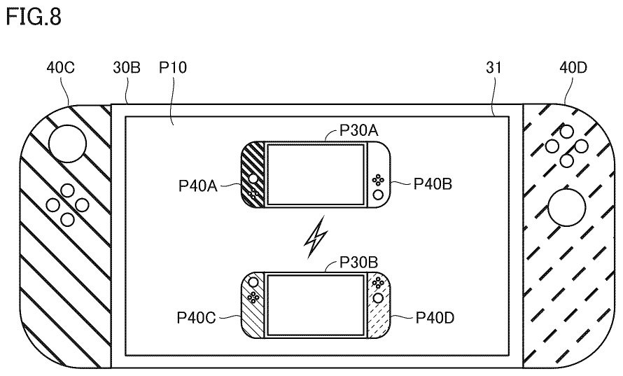

An exemplary image P10 shown on display 31 of main body apparatus 30B in step S209 will be described with reference to FIG. 8. As shown in FIG. 8, image P10 includes images P30A and P30B and images P40A to P40D. Images P30A and P30B are images that show main body apparatuses 30A and 30B, respectively. Images P40A to P40D are images that show controllers 40A to 40D, respectively. Images P30A and P30B may collectively be referred to as an “image P30” below without being distinguished from each other and images P40A to P40D may collectively be referred to as an “image P40” below without being distinguished from one another.

Color information is reflected on images P40A and P40B as the appearance of controllers 40A and 40B. Images P30A and P30B may be a common image that generally shows main body apparatus 30, or an image on which the appearance specific for each main body apparatus 30 is reflected, with the color information or the like being reflected thereon based on main body appearance information 363, similarly to controller 40.

In an example shown in FIG. 8, the color information is reflected also on images P40C and P40D as the appearance of controllers 40C and 40D. Specifically, main body apparatus 30B may obtain the appearance information of controllers 40C and 40D attached to main body apparatus 30B from storage 36 thereof and have the appearance information reflected on images P40C and P40D.

FIG. 8 shows an exemplary screen in registration of the game terminal described above. The virtual game card is a service that allows, by insertion of the virtual game card in a certain game terminal, like a physical game card, play of a game application corresponding thereto at that game terminal. The virtual game card can also virtually be inserted, for example, interchangeably from the certain game terminal to another game terminal. In that case, the game application can no longer be played at the original game terminal but can be played at the game terminal to which the virtual game card has been inserted. Any technique to execute and restrict play of the game in accordance with insertion and removal of the virtual game card may be applicable. For example, the whole data of the game application may be obtained or erased, or only key information for decoding game application data may be obtained or erased. Such a service for interchangeable insertion of the virtual game card may be provided, for example, only between registered game terminals. At this time, in registration, by bringing the already registered game terminal (a first game terminal may be registered by a server or the like, for example, by Internet connection) and a game terminal desired to be registered closer to each other to be within a prescribed distance from each other, registration processing may be performed through short-range wireless communication. If a user owns three or more game terminals or there are three or more game terminals at the user's house, the user may be confused as to which game terminals should be brought closer to each other.

In the present embodiment, the appearances of controllers 40A and 40B are included in image P10 as shown in FIG. 8. Therefore, for example, the user who operates game terminal 3B more readily understands, simply by viewing image P10, that game terminal 3A should be brought closer. In the service associated with the virtual game card, processing for registering the game terminal is performed by bringing the game terminals closer to each other to be within the prescribed distance from each other, by way of example. In other examples, virtual game cards are interchanged between a certain game terminal and another game terminal, or the virtual game card is temporarily inserted in a game terminal which is not a registered game terminal. The virtual game card service is an exemplary service in which the game terminals are brought closer to each other to be within the prescribed distance from each other, and a similar situation may occur in another service. For example, such a situation may include a situation where data or the like saved in a certain game terminal is copied or transferred to another game terminal, a situation where a communication game of a certain game application is executed between specific game terminals, and the like.

An example in which controller 40A is removed will be described with reference back to FIG. 7. Attached controller 40A is removed from game terminal 3A (step S210). In succession, nickname information of game terminal 3A is changed based on an operation by the user (step S211). Since change of the nickname information is included in the transmission condition for transmission of the data package, main body apparatus 30A transmits the data package (step S212). Persistent connection server Pe updates game terminal information database 262 in connection with game terminal 3A, based on the data package received from game terminal 3A (step S213).

At this time, main body apparatus 30A transmits controller appearance information 461 of already removed controller 40A that is held in memory 35, as being incorporated in the data package. In the present embodiment, controller appearance information 461 in the data package to be transmitted is not updated even when the controller is removed.

Persistent connection server Pe can thus hold information on controller 40A last attached to main body apparatus 30A, as the information on game terminal 3A, also after controller 40A is removed. In the present embodiment, persistent connection server Pe does not hold information indicating that controller 40A has been removed from game terminal 3A. Persistent connection server Pe may recognize that controller 40A has been removed from game terminal 3A, for example, based on the information included in the data package, and then hold controller appearance information 461 of controller 40A. Therefore, for example, even when the service providing server receives the service request again from game terminal 3B or the like after removal of controller 40A, the information processing terminal that issues the service request, such as game terminal 3B, can show image P10 including the appearance information of controller 40A last attached to game terminal 3A.

In succession, an example where a controller 40E is newly attached to main body apparatus 30A in steps S214 to step S217 is shown. Since processing in step S214 to step S217 corresponds to processing in steps S201 to S204, description will not be repeated. Persistent connection server Pe can thus update the appearance information of controller 40A to the appearance information of newly attached controller 40E and keep holding the appearance information of already attached controller 40B.

### E. Another Exemplary Image by Provision of Service

It has been explained that the service to be provided by service providing server SP may be, for example, the service associated with the virtual game card. The service to be provided by service providing server SP is not limited thereto, and for example, a service to supervise a state of at least one game terminal 3 for terminal 50 may be applicable.

The service may include, for example, a service to have a user who operates terminal 50 set a type of a game that can be played at game terminal 3 or a play limit time. In this case, in the flowchart in FIG. 7, terminal 50 instead of game terminal 3B requests service providing server SP for the service. The service may be available to game terminal 3B.

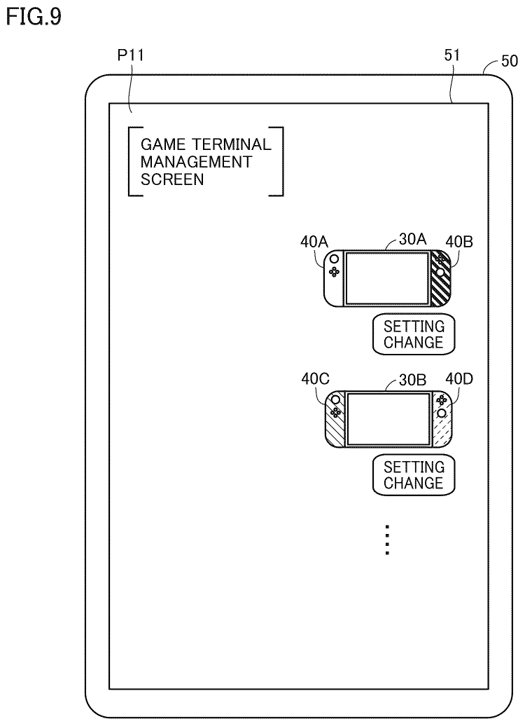

An exemplary image P11 shown at terminal 50 will be described with reference to FIG. 9. Image P11 is generated, for example, by execution of supervision application program 561 of terminal 50. Service providing server SP may hold information that allows identification of game terminal 3 set as a target to be supervised by an account associated with terminal 50. In an example in FIG. 9, both of game terminals 3A and 3B are registered in service providing server SP as targets to be supervised by the account associated with terminal 50.

Terminal 50 executes supervision application program 561 to request service providing server SP to execute the service for game terminals 3A and 3B. Service providing server SP obtains from persistent connection server Pe, the appearance information of controller 40 attached to game terminal 3 to be supervised and transmits the appearance information of controller 40 to terminal 50.

Terminal 50 can thus show images P40A to P40D on which the appearance information of controllers 40A to 40D attached to main body apparatuses 30A and 30B is reflected as shown in FIG. 9. As in the example in FIG. 8, the user who operates terminal 50 more readily understands simply by viewing image P11, which game terminal 3 is to be supervised and setting of which game terminal 3 should be changed. Such a supervision service is by way of example, and any service enjoyed by designation of one or more game terminals among a plurality of game terminals that may be located remotely from game terminal 3 or terminal 50 would achieve a similar effect. In FIGS. 8 and 9, text information for specifying main body apparatus 30 corresponding to image P30 may be shown in the vicinity of image P30.

### F. Modification

An example in which, after controller 40 is removed from main body apparatus 30, the appearance of controller 40 last attached to main body apparatus 30 is reflected on image P10 is described above. When controller 40 is removed from main body apparatus 30, however, the appearance of main body apparatus 30 to which controller 40 is not attached may be reflected on the image.

In this case, the transmission condition may include the fact that controller 40 has been removed. Main body apparatus 30 transmits to persistent connection server Pe, data indicating that controller 40 is not currently attached. The image of game terminal 3 that matches with an actual state of game terminal 3 can thus be shown in images P10 and P11. In an example where controller 40 has never been attached to main body apparatus 30 after shipment, an image showing a state where controller 40 is not attached may be shown, or a prescribed image or the like may be shown. The prescribed image may be generated by a server or another terminal based on reception of information that “controller 40 has never been attached” from main body apparatus 30, or generated by transmission to persistent connection server Pe, of prescribed controller appearance information 461 from main body apparatus 30 to which controller 40 has never been attached.

Controller appearance information 461 may be a predetermined ID corresponding to a color rather than RGB information indicating the color itself. For example, controller appearance information 461 may be model information indicating a model of controller 40, and persistent connection server Pe or the like may determine the color of controller 40 based on the model information.

Though an example in which the color information of controllers 40A to 40D is reflected on images P40A to P40D is described above, the shape may be changed based on the model information of controller 40. For example, images P40A to P40D may be shown as images different in accordance with actual shapes of controllers 40.

FIG. 7 illustrates an example in which controller appearance information 461 is included in the data package and successively transmitted to controller 40, main body apparatus 30A, persistent connection server Pe, service providing server SP, and main body apparatus 30B in this order. Controller appearance information 461 does not have to always maintain identical information during a course of transmission but contents of data may partially be modified so long as the appearance of controller 40 can be specified.

FIG. 7 illustrates an example in which service providing server SP requests persistent connection server Pe to provide information on game terminal 3A. Main body apparatus 30B, however, may request persistent connection server Pe to provide the information on game terminal 3A, without service providing server SP being interposed. Furthermore, main body apparatus 30B may directly request main body apparatus 30A to provide information on game terminal 3A without service providing server SP and persistent connection server Pe being interposed. In other words, system 100 does not have to include service providing server SP and persistent connection server Pe.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A system comprising at least one memory storing instructions that, when executed, cause at least one computer of the system to perform operations comprising:
receiving from a first main body apparatus among a plurality of main body apparatuses to each of which one or more controllers are removably attachable, first data corresponding to an appearance of a first controller attached to the first main body apparatus;
generating a third image comprising a first image that depicts an appearance of the main body apparatus and a second image that depicts the appearance of the first controller based on the first data; and
causing second main body apparatus different from the first main body apparatus to show the third image.

2. The system according to claim 1, wherein,
when no controller is attached to the first main body apparatus, the first data received from the first main body apparatus corresponds to an appearance of a controller last attached to the first main body apparatus.

3. The system according to claim 1, the operations comprising:
generating a sixth image comprising a fourth image that depicts an appearance of the main body apparatus and a fifth image that depicts an appearance of a second controller attached to the second main body apparatus; and
causing the second main body apparatus to show the sixth image with the third image.

4. The system according to claim 1, wherein
the first data comprises information indicating a color of the first controller.

5. The system according to claim 1, further comprising a first server configured to persistently be connected to at least the first main body apparatus, wherein
the first server is configured to receive the first data.

6. The system according to claim 1, the operations comprising:
receiving second data corresponding to the appearance of the first main body apparatus from the first main body apparatus, wherein
the first image depicts the appearance of the first main body apparatus based on the second data.

7. The system according to claim 3, wherein
the first image and the fourth image are a common image that depicts the main body apparatus.

8. A method comprising:
receiving from a first main body apparatus among a plurality of main body apparatuses to each of which one or more controllers are removably attachable, first data corresponding to an appearance of a first controller attached to the first main body apparatus;
generating a third image comprising a first image that depicts an appearance of the main body apparatus and a second image that depicts the appearance of the first controller based on the first data; and
causing second main body apparatus different from the first main body apparatus to show the third image.

9. The method according to claim 8, wherein,
when no controller is attached to the first main body apparatus, the first data received from the first main body apparatus, corresponds to an appearance of a controller last attached to the first main body apparatus.

10. The method according to claim 8, the method comprising:
generating a sixth image comprising a fourth image that depicts an appearance of the main body apparatus and a fifth image that depicts an appearance of a second controller attached to the second main body apparatus; and
causing the second main body apparatus to show the sixth image with the third image.

11. The method according to claim 8, wherein
the first data comprises information indicating a color of the first controller.

12. The method according to claim 8, wherein
a system comprises a first server configured to persistently be connected to at least the first main body apparatus, wherein
the receiving first data is performed by the first server.

13. The method according to claim 8, the method comprising:
receiving second data corresponding to the appearance of the first main body apparatus from the first main body apparatus, wherein
the first image depicts the appearance of the first main body apparatus based on the second data.

14. The method according to claim 10, wherein
the first image and the fourth image are a common image that depicts the main body apparatus.

15. A non-transitory computer-readable medium storing executable instructions that, when executed, cause at least one computer to perform operations comprising:
receiving from a first main body apparatus among a plurality of main body apparatuses to each of which one or more controllers are removably attachable, first data corresponding to an appearance of a first controller attached to the first main body apparatus; and
generating a third image comprising a first image that depicts an appearance of the main body apparatus and a second image that depicts the appearance of the first controller based on the first data; and
causing second main body apparatus different from the first main body apparatus to show the third image.

16. The non-transitory computer-readable medium according to claim 15, wherein,
when no controller is attached to the first main body apparatus, the first data received from the first main body apparatus corresponds to an appearance of a controller last attached to the first main body apparatus.

17. The non-transitory computer-readable medium according to claim 15, the operations comprising:
generating a sixth image comprising a fourth image that depicts an appearance of the main body apparatus and a fifth image that depicts an appearance of a second controller attached to second main body apparatus; and
causing the second main body apparatus to show the sixth image with the third image.

18. The non-transitory computer-readable medium according to claim 15, wherein
the first data comprises information indicating a color of the first controller.

19. The non-transitory computer-readable medium according to claim 15, wherein
the at least one computer of one or more servers is configured to persistently be connected to at least the first main body apparatus.

20. The non-transitory computer-readable medium according to claim 15, the operations comprising:
receiving second data corresponding to the appearance of the first main body apparatus from the first main body apparatus, wherein
the first image depicts the appearance of the first main body apparatus based on the second data.
